(19) United States
(12) Patent Application Publication
(10) Pub. No.: US 2010/0241571 A1
(43) Pub. Date: Sep. 23, 2010

(54) SYSTEM AND METHOD FOR CARDLESS SECURE ON-LINE CREDIT CARD/DEBIT CARD PURCHASING

(76) Inventor: GREG MCDONALD, Orleans (CA)

Correspondence Address: J. GORDON THOMSON, P.O. BOX 8865, VICTORIA, BC, V8V 3Z1, CA

(21) Appl. No.: 12/408,325

(22) Filed: Mar. 20, 2009

(51) Int. Cl. H04L 9/32; G06Q 30/00; G06F 17/30; G06F 3/048

(52) U.S. Cl. 705/74; 705/26; 705/27; 705/76; 715/780

(57) ABSTRACT

The invention is a system and method for cardless secure on-line purchasing using a credit/debit card. There is provided an on-line purchaser executing an on-line purchase with an on-line vendor having a credit/debit card payment screen. There is also at least one on-line credit/debit card service provider having an interface with the on-line purchaser the said on-line vendor. An e-authentication and credential service provider has an interface with the on-line purchaser and said at least one on-line credit/debit card service provider and provides means for secure on-line purchasing on a subscription basis by providing anonymity to the on-line purchase by hiding credit/debit card data during the on-line purchase making the purchase invisible to identity thieves and hackers.

### BACKGROUND

1. Field of the Invention

This invention is related to the field of information security and more particularly to access control and authentication and specifically to a system and method for cardless secure on-line credit card/debit card based purchasing.

2. Background of the Invention

Digital commerce is still plagued by such things as phishing, identity theft, pharming, man-in-the-middle and denial of service attacks. These serve to diminish confidence in digital commerce and result in significant financial losses to both on-line vendors and purchasers.

A number of solutions have been proposed such as PKI encryption, security tokens and passwords. However, experience has shown that each of these methods can be compromised and counterfeited. Identities and credit card data are particularly vulnerable as they must be revealed during on-line credit card transactions.

Therefore, there is a continued need to provide a security method that can further build citizen trust and confidence in conducting electronic business and protecting personal information transferred over electronic communication systems.

### SUMMARY

One object of the present invention is to improve citizen confidence in on-line credit-card/debit card transactions by providing a subscription based system and method for anonymous on-line purchasing using a credit card or a debit card that renders the on-line purchaser and their credit or debit card information anonymous and invisible to identity thieves and transaction manipulation hackers.

The system and method of the present invention uses a Personal Digital Identity Token or PDIT. The PDIT has recorded upon it a biometric of the on-line purchaser with a means that provide a link to a set of proven civil identity credentials, that have been obtained from competent civil registration authorities such as passport offices, drivers' license bureaus, government social insurance number issuers, health care card issuers, police forces, banking institutions and credit card providers. These civil identity credentials are recorded by an e-Authentication & Credential Service Provider (EACS) and by the relevant civil registration authority that holds the civil identity credentials. There can be other non-authority bodies that may also provide proven civil identity credentials for binding to the EACS database such as health clubs and libraries. In this manner, the EACS database will contain a plurality of strong that is, registration authority-issued civil identity credentials, and weak civil identity credentials issued by non-government registration authorities. Generally, the more civil identity credentials bound to the PDIT serial number the stronger the authentication assurance of the holder's identification will be. The combined biometric and bound civil identity credentials provide a highly reliable physical and civil authentication of the person holding the PDIT.

The present invention teaches a subscription based system and method for secure on-line purchases that uses a PDIT upon which there is a biometric of the on-line purchaser and linkages to a set of bound civil identity credentials of the on-line purchaser to authenticate his or her identity. The token is issued by an independent third party known as the e-authentication and credential service provider (EACS). The EACS provides a confidential conduit between the on-line purchaser and the credit card/debit card issuer. The PDIT is used to verify the physical identity of the on-line purchaser electronically through the use of a biometric and providing assurance of the on-line purchaser's civil identity credentials previously bound to the PDIT in the presence of an authorized agent of a civil registration authority. The identity of the on-line purchaser can be validated at a specified authentication assurance level described in the table in FIG. 1. However, for the purposes of on-line purchasing described in this specification, the required levels of authentication are levels 3 and 4. The authentication assurance levels (AAL) 1-4 were established by the National Institute of Standards and Technology (NIST). References in this document to authentication assurance levels can be associated by the reader with the NIST AAL 1-4 standards.

Once the on-line purchaser who holds the PDIT has had his or her physical identity authenticated biometrically and through the set of bound civil identity credentials, the invention provides for the issuance of temporary credit card information including the a temporary credit card number (TCCN), temporary credit card verification number (TCVN) and temporary credit card expiry date (TED). These are sent by the credit card issuer to the on-line purchaser by way of the EACS provider using an optical cryptographic container that is capable of being decrypted by the PDIT. Once decrypted, the temporary credit card information is displayed on the screen of the PDIT. The on-line purchaser enters this temporary credit card data into the on-line vendor's credit card payment screen and finalizes payment. The credit card issuer recognizes the temporary credit card data and will pay the vendor the purchase amount while billing the on-line purchaser's real credit card. In this manner, the true credit card information required for the purchase is not keyed into the computer or displayed on a screen thereby protecting it from hackers, phishers and man-in-the middle attacks.

### ADVANTAGES AND OBJECTIVES OF THE INVENTION

It is one objective of the present invention to provide a subscription based system and method that improves the security of on-line credit card/debit card transactions, authenticate the physical identity of the on-line purchaser, provides civil identity credential assurance of the on-line purchaser and delivers to the on-line purchaser secure temporary credit card information.

It is another object of this invention to create an on-line purchasing environment that provides for the selective disclosure of civil identity credentials of on-line purchasers and retains their credit card/debit card data anonymous to on-line vendors during credit card/debit card transactions.

It is yet another object of this invention to create a secure communication channel between the on-line purchaser, the EACS, and the credit card services provider.

Another objection is to provide a subscription based system and method of providing no credit card/debit card information to protect against identity theft.

Yet another objection of the invention is to provide protection against credit/debit card and identity fraud.

One advantage of the invention is that each on-line credit card/debit card transaction is auditable.

### BRIEF DESCRIPTION OF THE FIGURES

FIG. 1 is a table of authentication assurance levels.

FIG. 2 is a schematic diagram of elements of an on-line purchase.

FIG. 3 is a schematic diagram of a PDIT of one embodiment of the invention.

FIG. 4 is the rear face of a PDIT of one embodiment of the invention.

FIG. 5 is a schematic of biometric scanning and binding to the persona digital identity token.

FIG. 6 is another schematic of a biometric scan and binding to the personal digital identity token.

FIG. 7 is a schematic of a third party credential validation process.

FIG. 7A is a view of the display screen of the PDIT.

FIG. 8 is another schematic of a third party credential validation process.

FIG. 9 is an entry computer screen of an on-line travel service provider.

FIG. 10 is a service identification screen of an on-line service provider.

FIG. 11 is an on-line purchaser identification screen.

FIG. 12 is a billing information screen of an on-line service provider.

FIG. 13 is a credit card information entry screen of an on-line service provider.

FIG. 14 is a log-on screen for the EACS.

FIG. 15 is a flickering screen sent to a third party social/civil authority for binding credentials.

FIG. 16 illustrates how the PDIT reads the code contained in the flickering screen.

FIG. 17 illustrates the icon used to request a finger print scan of the PDIT holder.

FIG. 18 illustrates the one time password.

FIG. 19 the list of on-line credit card identities held by the EACS.

FIG. 20 is the log on screen for the credit card service provider.

FIG. 21 is tile screen requesting the one time password.

FIG. 22 is the display screen of the PDIT showing the temporary credit card information.

### DESCRIPTION

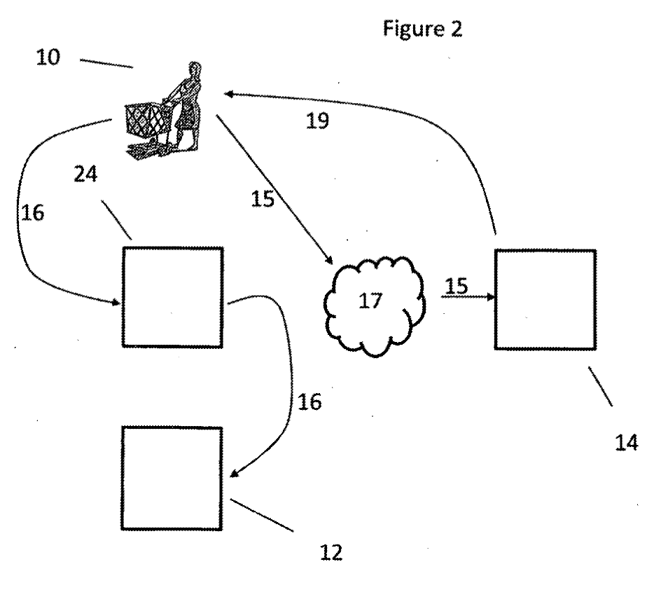

Referring now to FIG. 2 there is shown the primary elements of an on-line purchase. The invention is a subscription-based system and method for secure on-line credit card/debit card transactions involving an on-line purchaser 10, an on-line vendor 12, a credit card/debit card service provider 24 and an e-authentication and credential service provider (EACS) 14 which is an independent body. The invention requires the engagement of an EACS provider during the on-line credit card/debit card transaction 16 between the purchaser 10 and vendor 12 as exemplified herein. Throughout this disclosure, unless otherwise noted, the EACS provider will be a dedicated third party EACS provider 14. However, it is possible for each credit card/debit card issuer 24 to act as an EACS provider for its own credit card/debit card holders. The invention binds both the physical identity of the on-line purchaser 10 verified through an “in person” physical biometric validation and the social/civil identity credentials of the on-line purchaser verified and bound “in person” through at least one of social/civil registration authorities such as employers, driver's license issuing authority, passport agencies, health care agencies, banks, credit card companies and the like.

Still referring to FIG. 2, in order for the on-line purchaser 10 to engage the system of the invention there is an enrollment process. In a first step of the enrollment process, the on-line purchaser 10 buys 15 a subscription from the EACS 14. Purchase of the subscription requires the on-line purchaser to enroll on-line with the EACS through its secure website 17 and its secure server. The enrollment process comprises a second step of the on-line purchaser providing the EACS with a suite of information comprising at least the following information:
Full Name
Full Home Address
Phone Number
Fax Number
E-mail
Date of birth
Photograph
Employer name and contact information
Other types of information may also be required but not listed above to suite the security requirements of the system.

The EACS secure website 17 will have all of the required fields and prompts to permit the on-line purchaser to provide the information digitally. Once the second step is completed and the required information is provided there is third step wherein the on-line purchaser pays the required subscription fee to the EACS provider. Payment can be made by an on-line credit card transaction or through the bank that issued the credit/debit card. The on-line account is accessible through the EACS provider website 17.

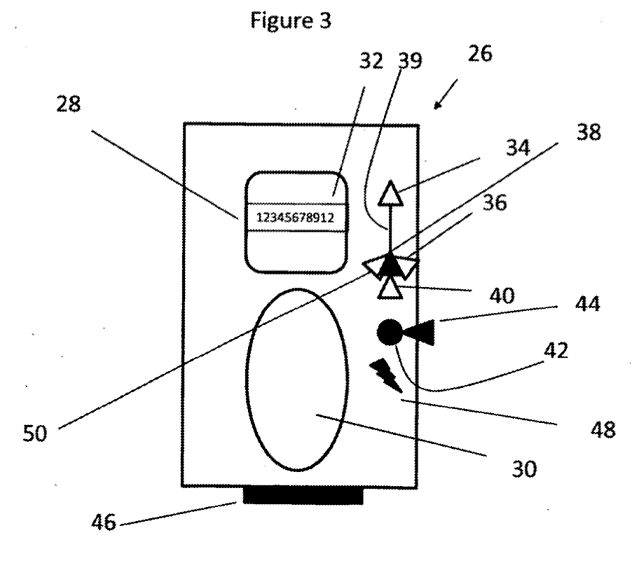

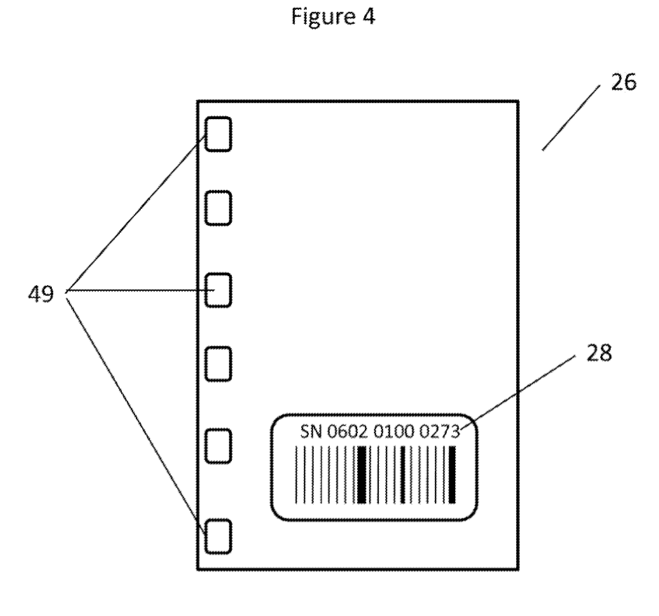

Referring to FIG. 2, FIG. 3 and FIG. 4, and in a fifth step, the EACS provider issues 19 the on-line purchaser a PDIT 26. The subscribing on-line purchaser's account and PDIT are both referenced by the PDIT's serial number 28. The PDIT serial number 28 appears as a 12 digit number as well as a machine readable bar code as shown in FIG. 4. As well, the serial number will appear on the display screen 32 of the PDIT every time it is turned on. The PDIT 26 is a hardware device that the on-line purchaser uses to record both biometric identity validation information and social/civil identity assurance information to achieve a required level of authentication for, as per this example, on-line credit card/debit card transactions. The PDIT is usable for many more applications other then online purchasing. In one embodiment of the invention the PDIT can provide secure physical identity-verification of the on-line purchaser to one hundred and twelve different online entities such as web portals requiring level 1 to level 4 authentications since it has 112 different secure communication channels each of which may be used to link the user with a specific online entity.

Still referring to FIG. 3 and FIG. 4 and in one embodiment of the invention, the PDIT has at least the following components:
Scanning means 30 to record the online purchaser's biometric data to be used for PDIT personalization. The biometric can be a fingerprint, a voice print, an iris print or any other suitable biometric.
A display screen 32 for displaying one-time-passwords, text messages, and corporate identification.
A data secure processor 34 to, amongst other duties, transform the scanned biometric into a digital biometric template.
Encryption and decryption software 36 used by the PDIT processor to encrypt and decrypt the biometric template.
An onboard memory 38 connected 39 to the onboard data secure processor 34 to store the biometric templates and operating software.
A match on card software 40 used by the processor and memory to compare a subsequently scanned biometric with the stored biometric.
An internal power source 42 with a connection to an external power source 46.
A USB interface 46 for hardwires connections to a computer and an external power source.
Encrypted connectivity means 48 to a computer including optical means, radio transmission means or sound means or a combination of them. FIG. 4 illustrates the location of optical readers 49 on the side of one embodiment of the PDIT as one example of optical crypto-connectivity between the PDIT 26 and a computer screen.

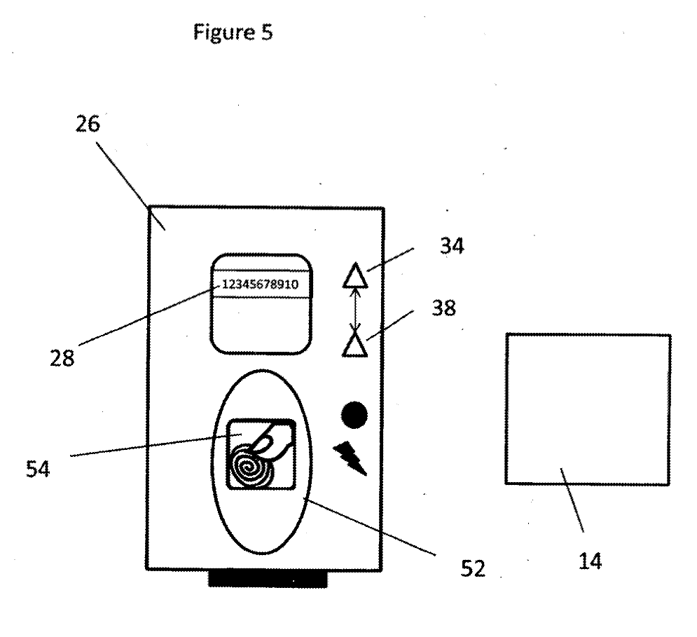

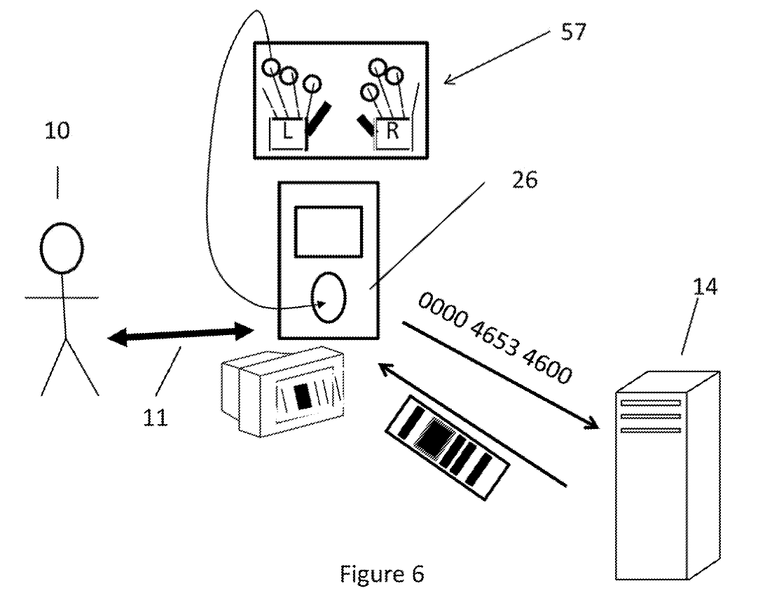

Referring now to FIGS. 5 and 6, and in a second process, the on-line purchaser personalizes the PDIT 26 by binding to it a biometric identifier which will verify the physical identity of the individual. For example, the PDIT may include a finger print scanner 52. The subscribing on-line purchaser 10 scans 11 a finger 54 of choice or multiple fingers 57 from one hand (depending on the demanded level of authentication required) into the PDIT. It will read the fingerprint and the on-board processor 34 will convert the print into a biometric template for secure and encrypted storage in the tamper proof memory device 38. The personalization process can only be done once and when completed the scanned and stored biometric template will constitute a digital physical identity credential for the on-line purchaser. The biometric is only stored on the PDIT and it is not transferred to the EACS provider 14. The latter can only verify that the on-line purchaser's PDIT was personalized by the on-line purchaser and this fact is recorded by the EACS by reference to the issued serial number 14.

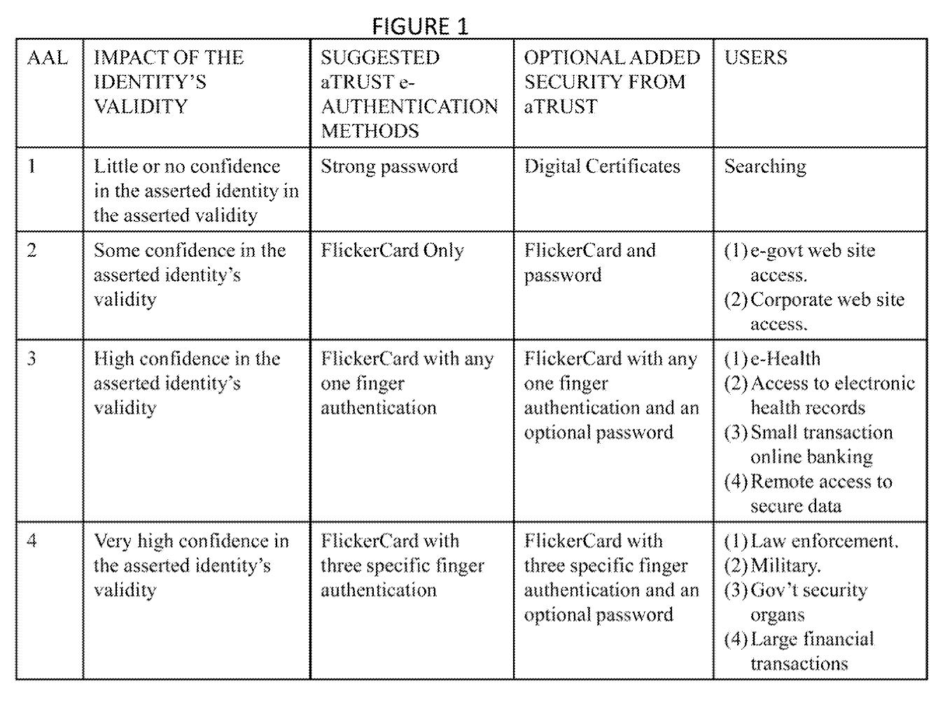

In a third process, the on-line purchaser 10 will bind digital social/civil identity credentials to the PDIT 26. These credentials are linked to the serial number of the PDIT in the presence of an authorized agent of a social/civil identity credential registration authority, such as a bank officer or a passport officer agent. As shown in FIG. 1, various levels of identity authentication assurance require different standards both physical/biometric and civil identity validation. This may include multiple finger scans, PINS and or passwords, and a set number of civil identity assurances. Generally, for credit/debit card transactions, authentication assurance level 3 will be sufficient, but individual banks, or credit/debit card companies may request a higher or lower authentication assurance level depending upon the purchase amount of the credit/debit card transaction.

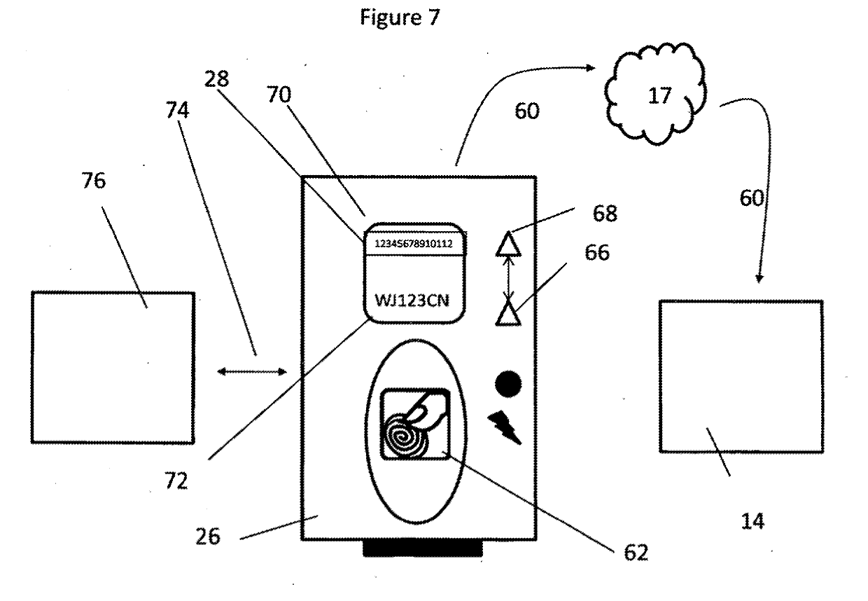

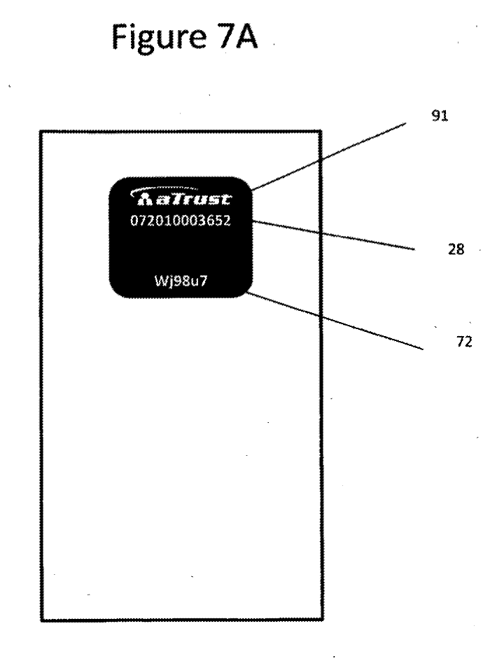

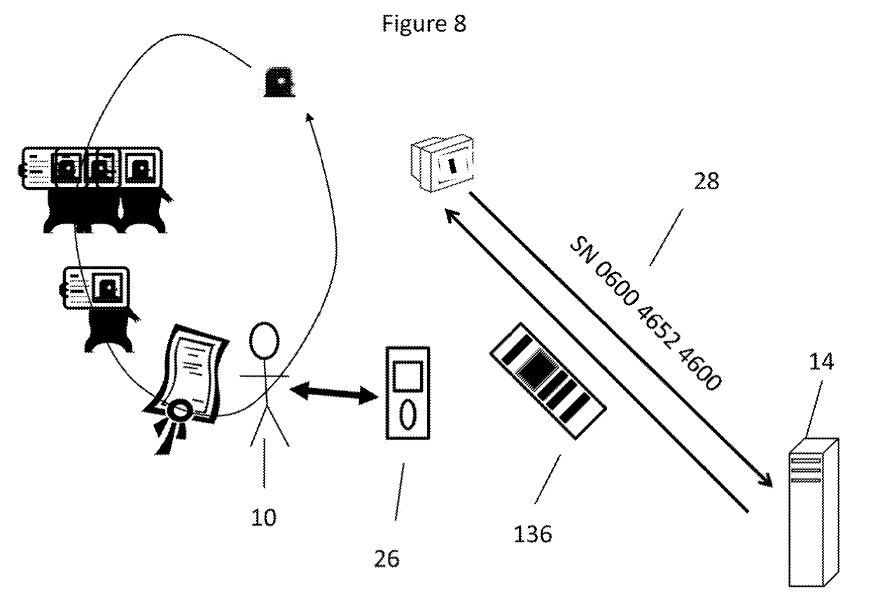

Referring to FIG. 7 and FIG. 8, the following examples are illustrative.

### EXAMPLE #1

The on-line purchaser may wish to bind banking data to the PDIT as a credential. Such a credential would be useful in validating that the on-line purchaser does have the bank accounts that he or she may have alleged. The banking data can comprise the following: bank account numbers, debit card number, credit card numbers and stock market trading account numbers. In each case, the banking data binding process is distinct and requires the physical presence of the on-line purchaser, the PDIT and the relevant authority, such as the bank manager or designate.

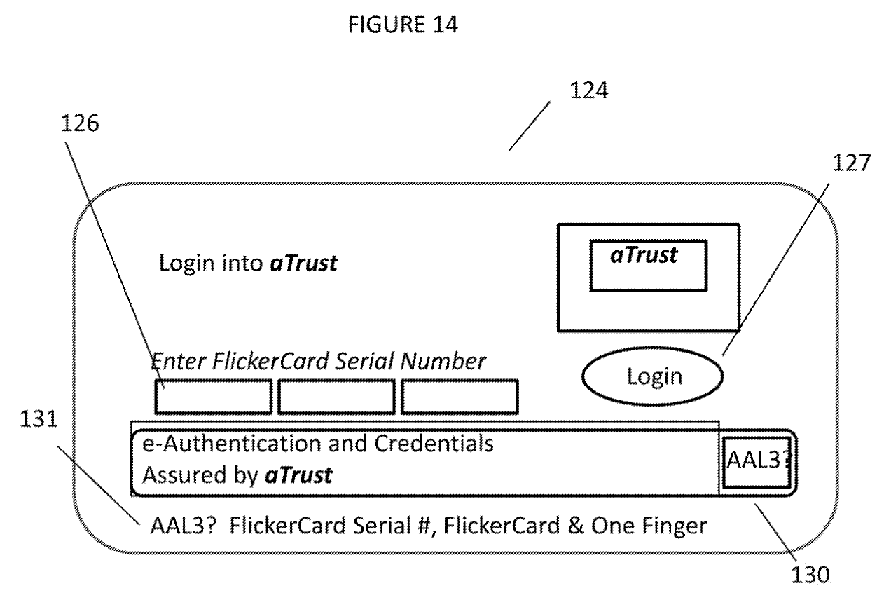

The on-line purchaser will attend the office of the registration authority, in this example a bank 76. The bank authority will request that the on-line purchaser perform a physical identity verified log on 60 to his or her EACS provider 14 account. This is done on-line through the EACS provider website 17 using the serial number 28 affixed to the back of the PDIT and displayed on the internal display of the PDIT initially when it is turned on. The on-line purchaser will be requested to authenticate his or her physical identity by conducting a biometric scan 62 using the PDIT 26. The on-line purchaser inputs his or her serial number 28 into the login display box item 126 in FIG. 14 on the EACS provider website 17. The EACS provider sends a secure flickering cryptographic optical container 136 to the bank's computer monitor 137 where the on-line purchaser is going through the process of validating his/her physical identity in the presence of an authorized agent of the bank. The EACS provider issues an Identity Validation Transaction Number (IVTN) directly to the bank which the bank uses to link the on-line purchaser's serial number 28 to his or her IVTN that is kept in the bank's and the EACS's secure databases. The EACS provider will build an auditable log of IVTNs and record the identity of the authorized agent of the bank conducting the identity validation. The on-line purchaser's PDIT serial number 28 is also linked 74 to the bank records used to validate the identity of the on-line purchaser. The on-line purchaser holds the PDIT 26 against the flickering cryptographic container 136 on the bank's computer monitor's screen 137 which decrypts the flickering cryptographic container 136 and displays instructions to the token holder requesting Level 3 or Level 4 authentication on the PDIT secure internal display 70. The on-line purchaser swipes his or her finger on the biometric scanner 52 to gain access to the on-line purchaser's account which contains a list of credit card companies that the on-line purchaser uses. This account is located on the EACS server. The EACS provider will not have any account numbers of the actual bank account, credit card, stock account and other credential data that has been bound by one or more registration authorities to the PDIT's serial number. To meet privacy concerns and to protect the data from hackers and data thieves, the EACS provider will only know that the on-line purchaser has a bank account with a particular bank, a credit card with a particular credit card company, and a stock market trading account, a driver's license, etc, but will not know the particulars of these on-line purchaser's identity credentials. Therefore, there is no transfer of sensitive credit card data or other identity data that can be compromised by on-line thieves.

FIG. 7A indicates where the serial number 28 is displayed on the PDIT screen; where the EACS or other service provider such as a bank or a credit company's logo 91 is displayed; and, where the one time password 72 is displayed.

### EXAMPLE #2

The on-line purchaser is able to bind passport data to the PDIT by visiting the local passport office. The on-line purchaser logs on to his or her on-line account with the EACS and provides a physical identity validation by conducting a biometric scan. Once the scan is confirmed as authentic the PDIT will issue a unique IVTN to log the validation at the passport office. The passport office will permit the PDIT's identity binding software to communicate with the passport office, to authenticate the passport office identity credential of the on-line purchaser. This data is then bound to the PDIT's serial number and confirms that the on-line purchaser does hold a passport Again the EACS provider will not know the specifics about the passport but will only know that the on-line purchaser has a passport and that identity described in the passport has been validated against the physical identity of the on-line purchaser in the presence of an authorized agent of the passport office.

Other examples are possible using the on-line purchaser's health care plan, employer and social insurance or social security number. All of these civil identity credentials can be digitally bound to the PDIT's serial number by having the on-line purchaser visit each registration authority, log on to the EACS provider website, authenticate physical identity using a biometric scan, obtain an IVTN which is stored in the registration authorities' and the EACS provider's databases for auditable and physical identity validation and identity credential assurance purposes. The aggregate result of these identity validation processes is the creation of multi-level identity & credential binding to achieve whatever level of identity validation & credential assurance that is required by the various relying parties which in this particular example are financial institutions. Reliability of identity assurance can be built up using a series of credentials from unrelated and independent sources all stored on the PDIT. The aggregation of bound identities on the PDIT can demonstrate the strength of an identity over time.

Only the holder's biometric data is contained on the PDIT in the form of encrypted, digitized and tamper proof information. Loss or theft of the PDIT will not result in loss of the credit card information or personal identity information as it is not stored on the PDIT. The third party EACS provider only records the types of civil identity credentials that were bound to the token by cross-referencing them to the token serial number. The actual private information, such as debit card number or credit card number is not recorded by the EACS provider, only the fact that the on-line purchaser does have a credit card(s), a debit card, a bank account, or a passport or a driver's license.

The following example shows how the system and method of the present invention is used in retaining credit/debit card privacy and security in an on-line credit/debit card transaction.

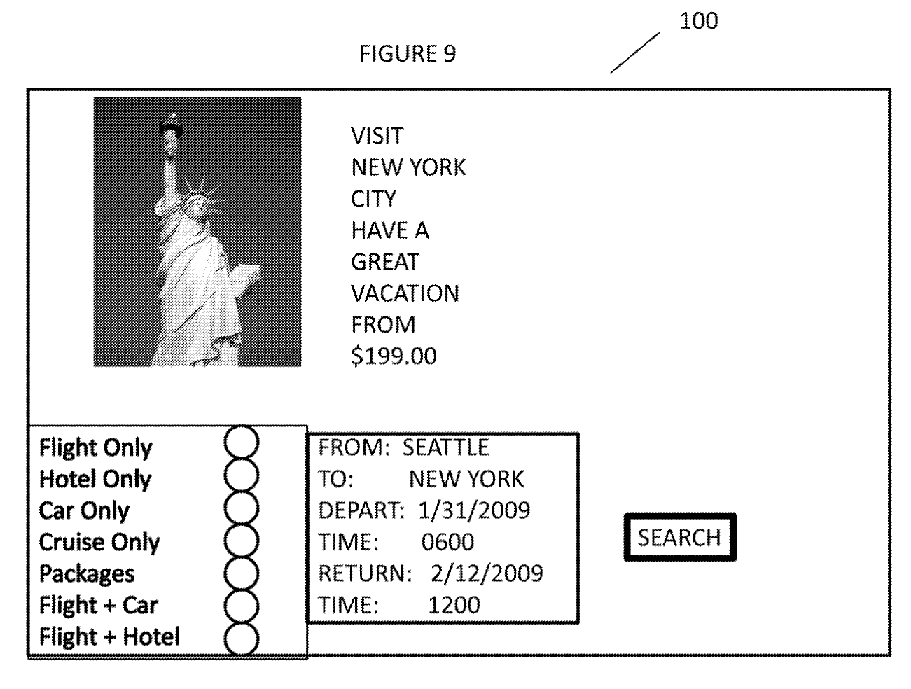

Referring now to FIG. 9, there is shown one example of a website 100 that an on-line purchaser may wish to use to purchase services using a credit/debit card. In the example shown the website is for the on-line purchase of an air flight from Ottawa to Mexico.

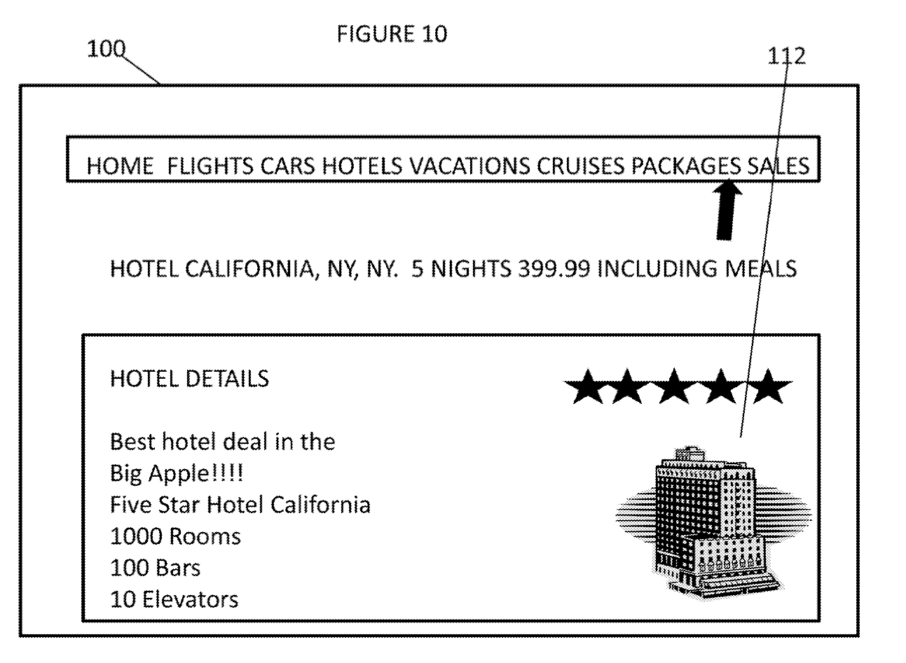

In FIG. 10, the on-line purchaser selects a hotel package 112.

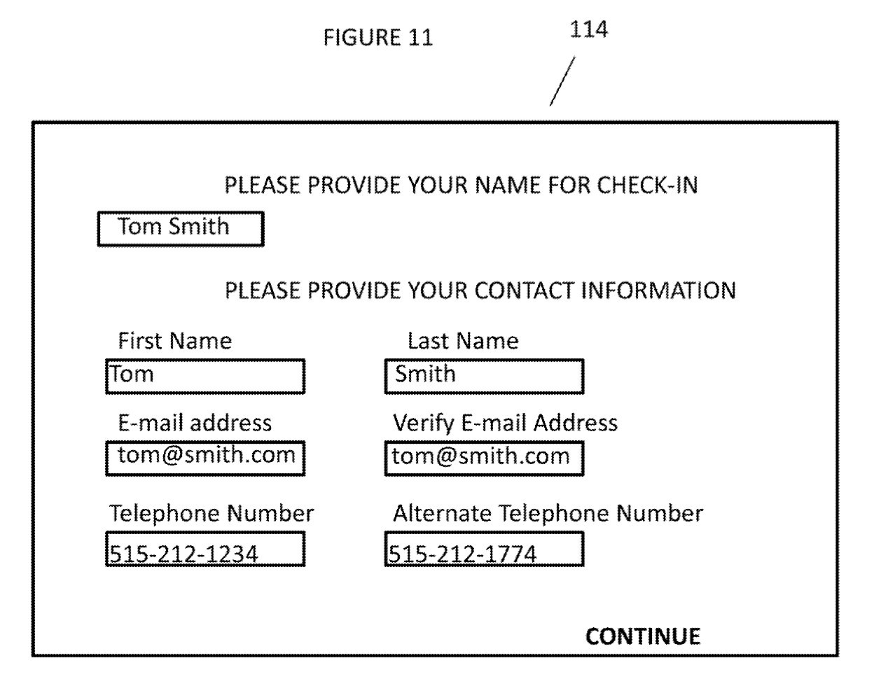

In FIG. 11, the on-line purchaser inputs standard information into the vendor's website 114.

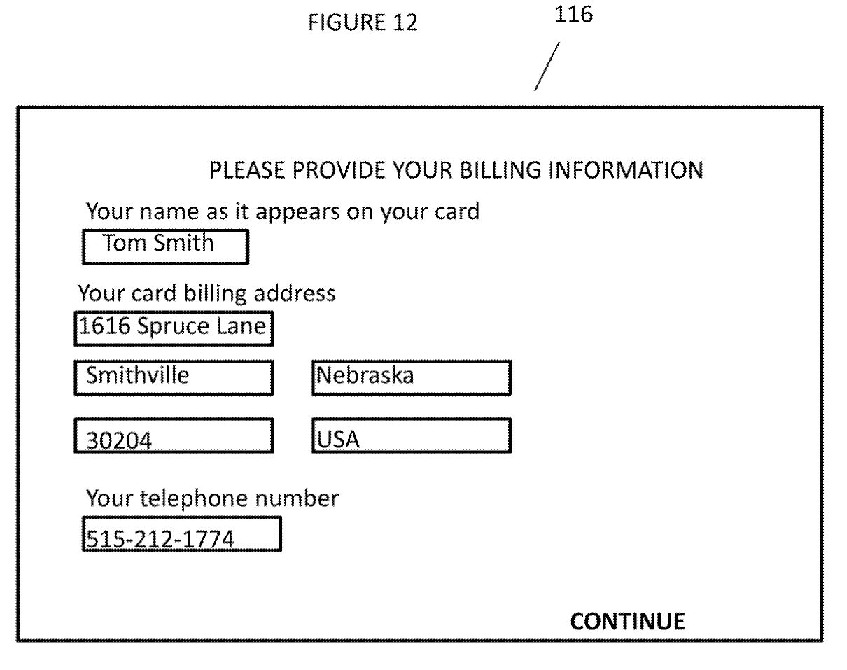

In FIG. 12, the on-line purchaser is requested by the on-line vendor to input personal information 116.

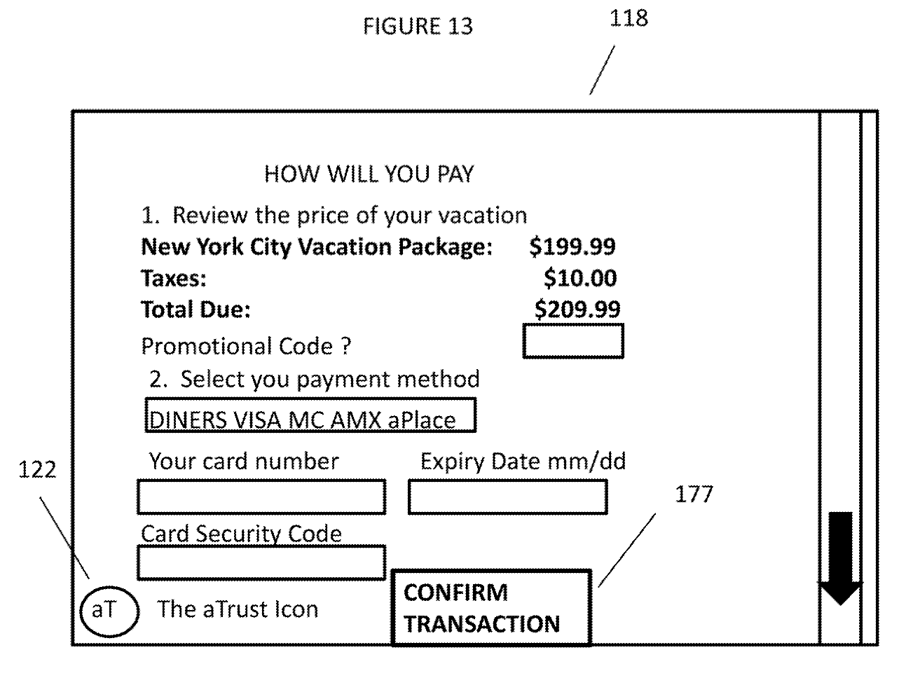

In FIG. 13, the credit card payment screen 118 is displayed. Up to this point, the transaction can be vulnerable to hackers. However, there is no information displayed that cannot be readily identified in a phone book, such as name, address and telephone number. In FIG. 13, the on-line purchaser has selected payment by way of a credit card issued by aPlace Bank 120. This bank is also a subscriber to the EACS and has authorized use of its credit card by the on-line purchaser for on-line transactions. The on-line purchaser does not input credit card data at this step. Instead, the on-line purchaser relies on the system and method of the invention to preserve anonymity and invisibility to any hacker that may attempt to obtain credit card information. The bank and the credit card company also rely on the system and method of the invention to seek and obtain confirmation of the transaction from the on-line purchaser. True credit card information is never revealed in the transaction and so remains secret.

The on-line purchaser clicks onto the EACS provider icon 122 which takes the on-line purchaser to the EACS provider's website logon screen 124 as shown in FIG. 14. The on-line purchaser is invited to input the serial number that is tied physically and digitally to the PDIT into the appropriate field 126 and click the Login/Submit button 127. Note that the demanded level of authentication in this example 130 is AAL Level 3 which will require the PDIT holder to input the PDIT serial number and perform a single finger scan 131.

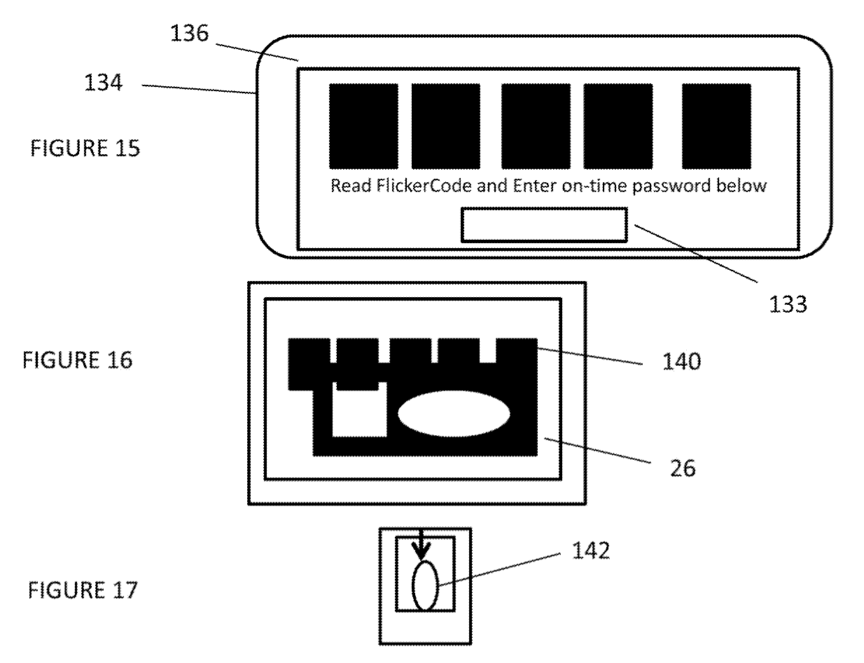

Referring to FIG. 15, the EACS provider will send to the on-line purchaser's computer screen a PDIT interface 136. This interface comprises encrypted data that only the on-line purchaser's PDIT can read. No other PDIT device is able to read the codes sent to a particular serialized PDIT. Any hacker obtaining the interface 136 is not able to decrypt the data and use the data without the specific PDIT identified in the encrypted data by the PDIT serial number.

The PDIT 26 is placed adjacent to the computer screen 140 as shown in FIG. 16 so that the optical readers on the PDIT can read the code embedded in interface.

As shown in FIG. 17, the EACS provider will then request that the PDIT holder perform a single fingerprint scan 142 to confirm the physical identity of the PDIT holder. The scan is done on the PDIT and the matching process is done on the PDIT using the on-board matching software previously identified.

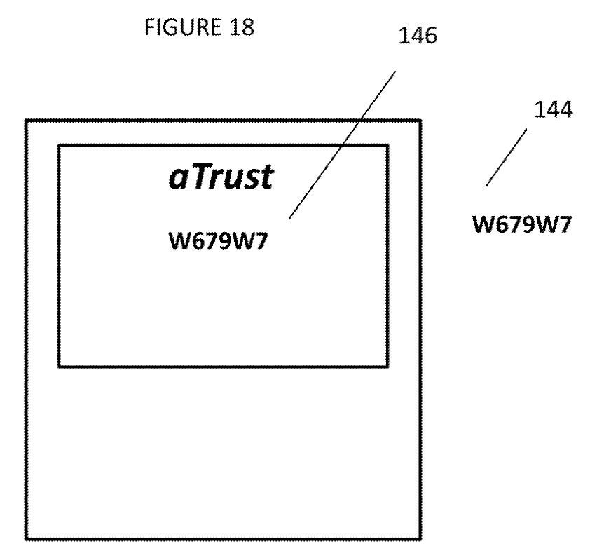

As shown in FIG. 18, once the PDIT holder is identified as the correct holder by the fingerprint scan and serial number validation, the PDIT will display a time-sensitive one-time password 144 on the PDIT internal screen 146. This password must be entered into the password box 133 shown on FIG. 15 within a specific amount of time. In one embodiment that amount of time is 90 seconds.

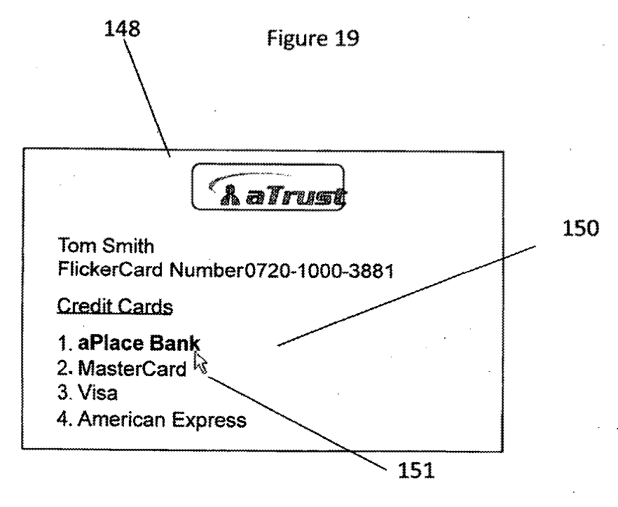

Once the password is entered, the EACS website will take the PDIT holder to an EACS screen 148 shown in FIG. 19 which lists the credit/debit card companies from which the on-line purchaser has received credit or debit cards 150 that are to be used for on-line purchases including the credit card issued by aPlace Bank. The on-line purchaser selects 151 the aPlace Bank credit card.

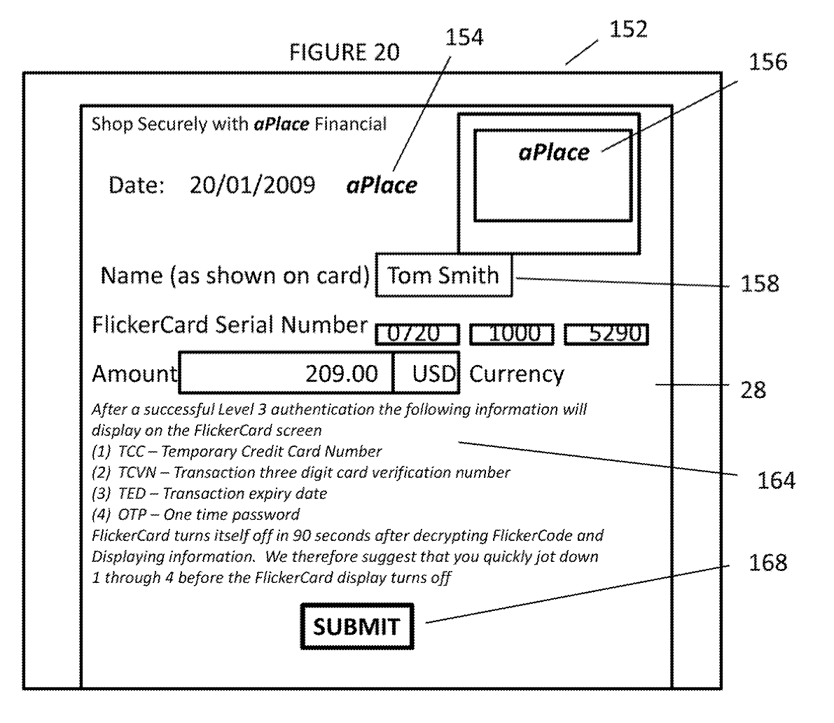

Once that is done, and referring to FIG. 20, the EACS provider will then take the on-line purchaser to the aPlace Bank credit card screen 152 wherein the aPlace Bank corporate security signature is displayed as shown by the aPlace digitally signed logo 156. This indicates to the on-line purchaser that he or she is logged on to the authentic aPlace bank website and not connected to a fake aPlace bank web site. The digitally signed aPlace Bank security logo 156 has been validated by the EACS. The corporate security signature is a unique security feature of the invention that involves the EACS digitally binding the legal corporate identity of the subscribing bank or credit card company in the form of its corporate logo with a digital security certificate. This process binds the legal corporate identity of the bank which owns the web portal being accessed by the PDIT holder to its legal corporate logo. This digital security certificate is associated with one of the PDIT's 112 secure communication channels, each of which are embedded with a 128 bit Elliptical Curve Cryptography (ECC) security certificates. Whenever a bank communicates with a PDIT via the EACS, the corporate security signature in the form of its digitally signed corporate logo 156 is shown on the PDIT display. This provides the PDIT holder with assurance of the identity of the bank and makes impersonation (phishing, pharming and man-in-the-middle attacks) impossible. A bank's digitally signed and encrypted corporate signature, bound upon commissioning by the EACS server, can be considered as the “biometric” identity of the organization. Digitally signed, securely displayed, corporate security signatures displayed as corporate logos on the PDIT display protect all parties involved in a transaction including the corporation as well as the PDIT owner from abuse by impostors, phishers, and hackers.

The on line purchaser's name 158, the PDIT serial number 28, the amount of the purchase 162 and the currency of the purchase 164 are entered on the screen. The on-line purchaser then clicks the submit button 168. When the on-line purchaser presses the submit button 168 a second cryptographic optical container 136 is transmitted to the on-line purchaser's screen by the EASP. The on-line purchaser holds the PDIT 26 to the screen 140 and depending upon the amount of the on-line purchase an icon 142 is displayed on the screen requesting a one or more finger authentication. This is accomplished by the on-line purchaser scanning his/her finger 54 over the embedded finger scanner 52.

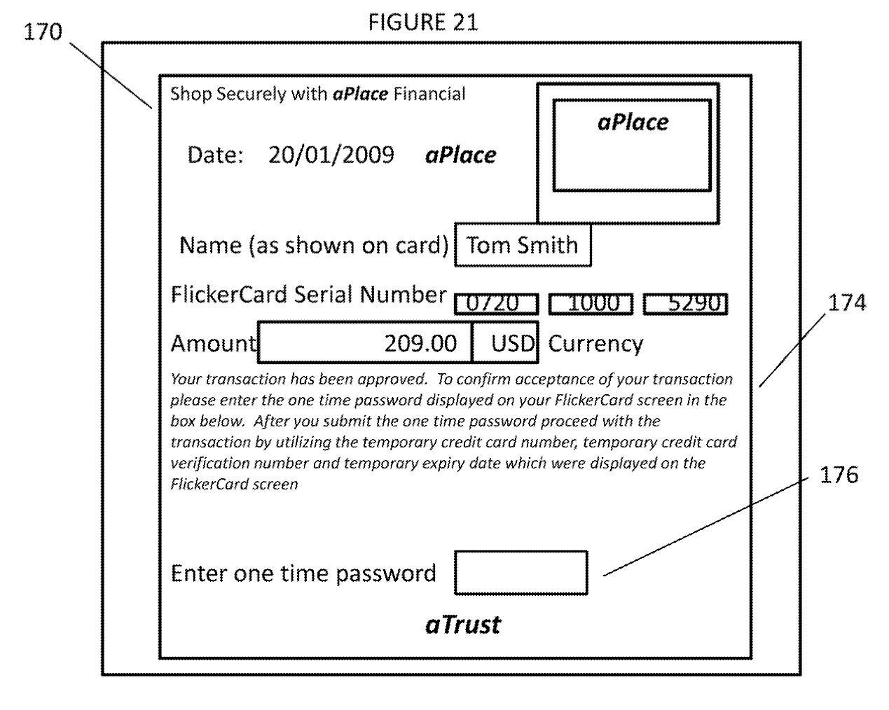

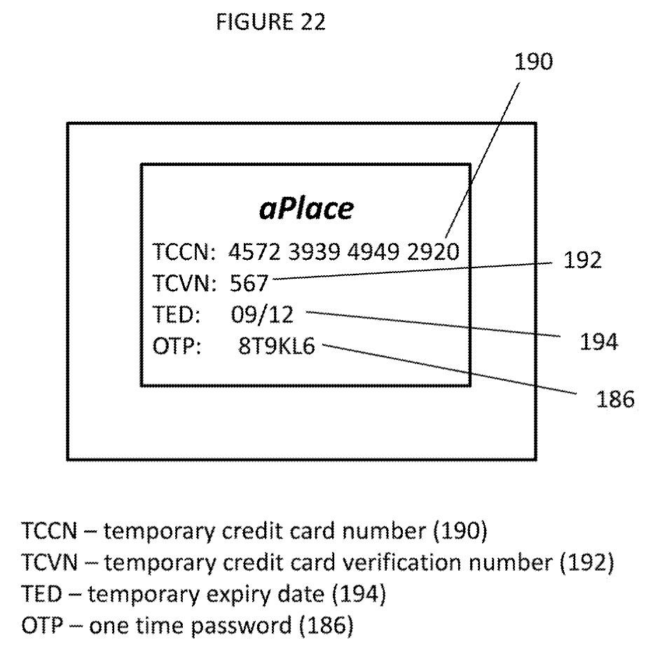

Referring to FIG. 21 and FIG. 22, the on-line purchaser is taken to a transaction approval screen 170 indicating at 174 the approval of the purchase and providing a box to enter a second time sensitive and on-time password (OTP) that will be displayed on the PDIT screen shown in FIG. 22 as item 186. Also displayed in the display window of the PDIT are: the temporary credit card number (TCCN) 190; the Temporary Credit Card Validation Number (TCVN) 192 the Temporary Expiry Date (TED) 194. Entry of the one-time password into box 176 in FIG. 21 will take the on-line purchaser back to the vendor's purchase screen shown in FIG. 13. In one embodiment of the invention the TCCN will contain a number of 16 digits. However, in other embodiments, and depending on the requirements of the credit/debit card issuer, the TCCN may comprise fewer digits. In one embodiment, the requirement for the TCCN may be a first group of credit/debit card numbers and a last group of credit/debit card numbers, for example, 4321 XXXXXXXX 1234.

The on-line purchaser will input this temporary information into the appropriate fields on FIG. 13 in lieu of the real credit card number. Once the information is provided, the on-line transaction will be complete and no true credit card information will have been transmitted over the Internet. The on-line purchaser confirms the purchase by clicking on the “Complete Transaction” button at the bottom of FIG. 13. This has the effect of the on-line purchaser creating a digital signature and further is a legal affirmation on the part of the on-line purchaser that he or she has consummated a transaction with legal consequences and intends to be bound by it. The on-line purchaser will have consented to this process during enrolment to the system. Alternatively, there may be a double click requirement on the part of the on-line purchaser whereby he or she clicks the “Complete Transaction” button a first time and is then presented terms setting out the affirmation of intent to be bound to the transaction, and clicks the “Complete Transaction” a second time to agree to the terms and complete the purchase.

The credit card service provider will also confirm that the transaction has been recorded and pays the on-line vendor the sum shown. Note that the credit card service provider pays the exact amount shown and does not deduct any fee since the parties to the transaction are paying subscription fees and or transaction fees to the third party credential service.

In another embodiment of the system and method of the invention the credit card service provider may add a service charge for the added security provided.

In one embodiment of the invention there is a cardless system for secure on-line purchasing using a credit/debit card. The system comprises an on-line purchaser executing an on-line purchase and having an interface with; an on-line vendor having a credit/debit card payment screen; at least one on-line credit/debit card service provider having an interface with the on-line purchaser and the on-line vendor; and, an e-authentication and credential service provider having an interface with the on-line purchaser and the at least one on-line credit/debit card service provider. The e-authentication and credential service provider provides means for secure on-line purchasing on a subscription basis that requires payment of a subscription fee and or as an alternative payment method a transaction fee. The means for secure on-line purchasing provides anonymity to the on-line purchase by hiding credit/debit card data during the on-line purchase making the purchase invisible to identity thieves and hackers.

The on-line purchaser and the at least one on-line credit/debit card service provider subscribe to the means for secure on-line purchasing. A personal digital identity token is issued to the on-line purchaser upon subscription (or was issued by another service provider for a different application) to the means by the e-authentication and credential service provider. The personal digital identity token is identified to the e-authentication and credential service provider by a serial number provided to the on-line purchaser during an enrolment process.

The on-line purchaser has at least one credit/debit card from the at least one credit/debit card provider. The name of the at least on one credit/debit card is bound to the serial number by the on-line purchaser during the civil identity binding process.

The enrolment process further includes the on-line purchaser providing a suite of information and binding the suite to the serial number.

The personal digital identity token includes biometric scanning and storage means. The on-line purchaser personalizes the personal digital identity token by scanning and storing at least one biometric thereupon. The personal digital identity token is capable of communicating with a computer by encrypted sound signals, encrypted light signals, encrypted radio frequency signals, or hardwire connections through a USB port. The communication with the e-authentication and credential service can take place through a cell phone, smart phone, PDA or other wireless device.

The system further includes at least one civil registration authority having identity credential data relevant to the on-line purchaser. The on-line purchaser confirms the existence of his identity credential data with the at least one civil registration authority. The at least one civil registration authority records the confirmation as a civil identity credential in their database along with the personal digital identity token serial number and with the e-authentication and credential service provider by way of an identity validation transaction number.

The at least one civil registration authority comprises a plurality of civil registration authorities each having identity credential data relevant to the on-line purchaser. The on-line purchaser confirms the existence of the identity credential data from each civil registration authority each recording the existence of the identity credential data in their database along with the personal digital identity token serial number. The personal digital identity token has at least one biometric on it and at least one civil identity credential on it and is used to access the e-authentication and credential service provider website from the on-line vendor credit/debit card payment screen during an on-line purchase using a credit/debit card.

The e-authentication and credential service provider requests that the on-line purchaser perform a first biometric scan of the at least one biometric and upon successful confirmation of the first biometric scan, the e-authentication and credential service provider issues the on-line purchaser an encrypted first temporary one-time password using a computer interface for decryption by the personal digital identity token.

The computer interface includes a field for entry of the one-time password. Upon decryption of the first temporary one-time password, the one-line purchaser enters it into the field.

Upon entry of the first temporary one-time password into the field, the on-line purchaser is presented with a list comprising the name of the at least one credit/debit card provider.

The on-line purchaser selects a credit card provider from the list of the at least one credit card provider. The on-line purchaser is taken by the e-authentication and credential service provider to the website of the credit card provider. The website has a field for a second one-time password.

The credit card issuer requests a second biometric scan and upon success of the second biometric scan, the credit card issuer issues the on-line purchaser a temporary credit card number, a temporary credit card validation number, a temporary expiry date and said second one-time password.

The on-line purchaser enters the second one-time password into the field and is taken to the on-line vendor credit/debit card payment screen. The screen has a data entry field for the temporary credit card number, the temporary credit card validation number and the temporary expiry date.

The on-line purchaser completes the on-line purchase by entering the temporary data into each field and clicks the transaction complete button on the on-line vendor credit/debit card payment screen.

The invention also discloses a method for secure on-line credit/debit card purchasing between an on-line purchaser, an on-line vendor and an on-line credit card service provider. The method comprising the steps of:
a. Providing an e-authentication and credential service provider having a website and secure on-line access to the website;
b. Enrolling the on-line purchaser and the on-line credit card service provider on a subscription basis into the e-authentication and credential service;
c. Obtaining a list of credit card names use by the on-line purchaser for on-line credit card purchases;
d. Issuing a personal digital security token having a serial number to the on-line purchaser by the e-authentication and credential service provider;
e. Recording at least one biometric on the personal digital security token by the on-line purchaser; and,
f. Recording at least one identity credential on the personal digital security token by the on-line purchaser.

The method further comprises, of on-line purchaser, the steps of:
a. Accessing the website of the e-authentication and credential service provider from the on-line vendor credit/debit card website;
b. Validating the at least one biometric using the personal digital security token;
c. Obtaining an encrypted first one-time password from the e-authentication and credential service provider;
d. Decrypting the one-time password using the personal digital security token;
e. Entering the one-time pass word into a field provided by the c-authentication and credential service provider;
f. Viewing a display of credit/debit cards authorized for on-line purchases;
g. Selecting one of said credit/debit card for the on-line purchase; and,
h. Moving to the website of the credit/debit card service provider.

The method further comprises, oil the part of the on-line purchaser, the steps of:
a. Validating a second biometric scan to the credit/debit card provider;
b. Upon successful validation of the second biometric scan, receiving from the credit/debit card provider the following credit card data: a temporary credit card number, a temporary credit card validation number, a temporary credit card expiry date and a second one-time password, wherein the credit card data is displayed on the personal digital security token;
c. Entering into data fields provided on the credit/debit card website the serial number, the name of the on-line purchaser, the amount of the purchase and the currency of the purchase;
d. Entering into a field provided on the credit/debit card website the second one-time password; and,
e. Moving to the one-line vendor credit/debit card payment screen.

The method further comprises, on the part of the on-line purchaser, the steps of:
a. Entering the temporary credit card number, temporary credit card validation number and temporary expiry date into the fields provided on the on-line vendor credit/debit card payment screen;
b. Completing the on-line purchase by clicking the confirm transaction button on the on-line vendor credit/debit payment screen.

The method further comprises the steps of:
a. On the part of the credit/debit card issuer:
   i. Paying the on-line vendor the on-line purchase amount;
   ii. Billing the on-line purchaser the purchase amount;
b. On the part of the e-authentication and credential service provider:
   i. Issuing a transaction number to the credit/debit card provider; and,
   ii. Storing said transaction number in an accessible memory.

Although the description above contains much specificity, these should not be construed as limiting the scope of the invention but as merely providing illustrations of the presently preferred embodiment of this invention. Thus the scope of the invention should be determined by the appended claims and their legal equivalents.

What is claimed is:

1. A system for secure on-line purchasing using a credit/debit card, said system comprising:
a. an on-line purchaser executing an on-line purchase and having an interface with;
b. an on-line vendor having a credit/debit card payment screen;
c. at least one on-line credit/debit card service provider having an interface with said on-line purchaser and said on-line vendor; and,
d. an c-authentication and credential service provider having an interface with the on-line purchaser and said at least one on-line credit/debit card service provider, wherein said e-authentication and credential service provider provides means for secure on-line purchasing on a subscription basis that requires payment of a subscription fee and or as an alternative payment method a transaction fee;
e. wherein said means for secure on-line purchasing provides anonymity to the on-line purchase by hiding credit/debit card data during the on-line purchase making the purchase invisible to identity thieves and hackers.

2. The system of claim 1, wherein the on-line purchaser and the at least one on-line credit/debit card service provider subscribe to said means, and wherein a personal digital identity token is issued to the on-line purchaser upon subscription (or was issued by another service provider for a different application) to said means by the e-authentication and credential service provider, and further wherein the personal digital identity token is identified to the e-authentication and credential service provider by a serial number provided to the on-line purchaser during an enrolment process.

3. The system of claim 1, wherein the on-line purchaser has at least one credit/debit card from the at least one credit/debit card provider, and wherein the name of said at least on one credit/debit card is bound to said serial number by the on-line purchaser during the civil identity binding process.

4. The system of claim 2, wherein the enrolment process further includes the on-line purchaser providing a suite of information and binding said suite to the serial number.

5. The system of claim 2, wherein the personal digital identity token includes biometric scanning and storage means, and wherein the on-line purchaser personalized the personal digital identity token by scanning and storing at least one biometric thereupon, and wherein the personal digital identity token is capable of communicating with a computer by encrypted sound signals, encrypted light signals, encrypted radio frequency signals, or hardwire connections through a USB port; and still further wherein the communication with the e-authentication and credential service and physical identity identification can take place through a cell phone, smart phone, PDA or other wireless device.

6. The system of claim 1, further including at least one civil registration authority having identity credential data relevant to the on-line purchaser, and wherein the on-line purchaser confirms the existence of said identity credential data with said at least one civil registration authority, and further wherein the at least one civil registration authority records said confirmation as a civil identity credential in their database along with the personal digital identity token serial number and with the e-authentication and credential service provider by way of an identity validation transaction number.

7. The system of claim 6, wherein the at least one civil registration authority comprises a plurality of civil registration authorities each having identity credential data relevant to the on-line purchaser, and wherein the on-line purchaser confirms the existence of said identity credential data from each civil registration authority each recording the existence of said identity credential data in their database along with the personal digital identity token serial number.

8. The system of claim 7, wherein the personal digital identity token having at least one biometric thereupon and at least one civil identity credential thereupon is used to access the e-authentication and credential service provider website from said on-line vendor credit/debit card payment screen during an on-line purchase using a credit/debit card.

9. The system of claim 8, wherein the e-authentication and credential service provider requests that the on-line purchaser perform a first biometric scan of said at least one biometric and upon successful confirmation of said first biometric scan, the e-authentication and credential service provider issues the on-line purchaser an encrypted first temporary one-time password using a computer interface for decryption by the personal digital identity token.

10. The system of claim 9, wherein said computer interface includes a field for entry of said one-time password, and whereupon decryption of the first temporary one-time password, the one-line purchaser enters it into said field.

11. The system of claim 10, where upon entry of the first temporary one-time password into the field, the on-line purchaser is presented with a list comprising the name of the at least one credit/debit card provider.

12. The system of claim 11, wherein the on-line purchaser selects a credit card provider from said list of the at least one credit card provider, and whereupon the on-line purchaser it taken by the e-authentication and credential service provider to the website of said credit card provider, said website having a field for a second one-time password.

13. The system of claim 12, wherein the credit card issuer requests a second biometric scan and upon success of said second biometric scan, the credit card issuer issues the on-line purchaser a temporary credit card number, a temporary credit card validation number, a temporary expiry date and said second one-time password.

14. The system of claim 13, wherein the on-line purchaser enters the second one-time password into said field and is taken to the on-line vendor credit/debit card payment screen, wherein the screen has a data entry field for said temporary credit card number, said temporary credit card validation number and said temporary expiry date.

15. The system of claim 14, wherein the on-line purchaser completes said on-line purchase by entering the temporary data into each field and clicks the transaction complete button on the on-line vendor credit/debit card payment screen.

16. A method for cardless secure on-line credit/debit card purchasing between an on-line purchaser, an on-line vendor and an on-line credit card service provider, said method comprising the steps of:
a. Providing an e-authentication and credential service provider having a website and secure on-line access to said website;
b. Enrolling said on-line purchaser and said on-line credit card service provider on a subscription basis into said e-authentication and credential service;
c. Obtaining a list of credit card names used by the on-line purchaser for on-line credit card purchases;
d. Issuing a personal digital security token having a serial number to the on-line purchaser by the e-authentication and credential service provider;
e. Recording at least one biometric on said personal digital security token by the on-line purchaser; and,
f. Recording at least one identity credential on the personal digital security token by the on-line purchaser.

17. The method of claim 16, further comprising, on the part of on-line purchaser, the steps of:
a. Accessing the website of the e-authentication and credential service provider from the on-line vendor credit/debit card website;
b. Validating said at least one biometric using the personal digital security token;
c. Obtaining an encrypted first one-time password from the e-authentication and credential service provider;
d. Decrypting said one-time password using the personal digital security token;
e. Entering the one-time pass word into a field provided by the e-authentication and credential service provider;
f. Viewing a display of credit/debit cards authorized for on-line purchases;
g. Selecting one of said credit/debit card for the on-line purchase; and,
h. Moving to the website of the credit/debit card service provider.

18. The method of claim 17, further comprising on the part of the on-line purchaser, the steps of:
a. Validating a second biometric scan to the credit/debit card provider;
b. Upon successful validation of said second biometric scan, receiving from the credit/debit card provider the following credit card data: a temporary credit card number, a temporary credit card validation number, a temporary credit card expiry date and a second one-time password, wherein said credit card data is displayed on the personal digital security token;
c. Entering into data fields provided on the credit/debit card website the serial number, the name of the on-line purchaser, the amount of the purchase and the currency of the purchase;
d. Entering into a field provided on the credit/debit card website said second one-time password;
e. Moving to the one-line vendor credit/debit card payment screen.

19. The method of claim 18, comprising the steps on the part of the on-line purchaser of:
a. Entering the temporary credit card number, temporary credit card validation number and temporary expiry date into the fields provided on the on-line vendor credit/debit card payment screen;
b. Completing the on-line purchase by clicking the confirm transaction button on the on-line vendor credit/debit payment screen, whereby said clicking of the confirm transaction button has a legal binding effect on the on-line purchaser to the transaction.

20. The method of claim 19, further comprising the steps of:
a. On the part of the credit/debit card issuer:
i. Paying the on-line vendor the on-line purchase amount;
ii. Billing the on-line purchaser the purchase amount;
b. On the part of the e-authentication and credential service provider:
i. Issuing a transaction number to the credit/debit card provider; and,
ii. Storing said transaction number in an accessible memory.
